(19) United States
(12) Patent Application Publication
(10) Pub. No.: US 2006/0187655 A1
(43) Pub. Date: Aug. 24, 2006

(54) Lighted bill folder

(76) Inventors: Lawrence R. Bryerman, Buffalo Grove, IL (US); Howard J. Bryerman, Cherry Hill, NJ (US)

Correspondence Address: WALLENSTEIN & WAGNER, LTD., 311 SOUTH WACKER DRIVE, 53RD FLOOR, CHICAGO, IL, 60606, US

(21) Appl. No.: 11/220,459

(22) Filed: Sep. 7, 2005

Related U.S. Application Data
(60) Provisional application No. 60/655,715, filed on Feb. 23, 2005.

(51) Int. Cl. F21V 33/00

(52) U.S. Cl. 362/154

(57) ABSTRACT

A light is provided for connecting to a bill folder. The light has a housing having a cavity containing an illumination source, a power source, and a switch electrically connecting the power source and the illumination source when in an actuated position. The light also has a translucent panel adjacent the cavity that is illuminated by backlighting from the illumination source. The light is connected to the bill folder for illuminating a bill on a flap of the bill folder.

### CROSS-REFERENCE TO RELATED APPLICATIONS

This application is a continuation-in-part of U.S. Provisional Patent Application Serial No. 60/655,715, filed on Feb. 23, 2005, which is expressly incorporated herein by reference.

### FEDERALLY SPONSORED RESEARCH OR DEVELOPMENT

Not Applicable.

### TECHNICAL FIELD

The present invention relates generally to an lighted bill folder, and more particularly to a light for a bill folder.

### BACKGROUND OF THE INVENTION

Bill folders are well known in the art. Standard bill folders include a folder having a means for retaining a bill and/or a financing card. While such bill folders according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a light for a bill folder. According to one embodiment the light comprises a housing a cavity, an illumination source located in the cavity, and a switch electrically connecting a power source and the illumination source when in an actuated position. The power source is preferably a series of batteries positioned within the housing. The housing also has a mounting member extending from the housing and configured to secure a bill folder thereto such that the light in the housing is fixed in position to illuminate a surface of the bill folder.

According to another embodiment, the light comprises a housing having a cavity with at least one illumination source located therein, a translucent panel adjacent the cavity, and a switch electrically connecting a power source and the illumination source when in an actuated position. The housing has a translucent panel that is illuminated by backlighting from the at least one illumination source. In one embodiment a surface of the translucent panel is faceted, and in another embodiment the face of the translucent panel has a design or indicia thereon and which is illuminated by the backlighting through the panel.

According to yet another embodiment, a lighted bill folder is provided and comprises a light module and a bill folder. The bill folder has a first flap pivotally connected to a second flap, and the light module is connected to the first flap of the bill folder. The light module has a housing, a switch extending from the housing, and a light source electrically connected to the switch. The light source directs illumination toward a surface of the first flap.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of the lighted bill folder in the actuated position;

FIG. 2 is a perspective view of one embodiment of the lighted bill folder in the non-actuated position;

FIG. 3 is a front elevation view of one embodiment of a light for the lighted bill folder;

FIG. 4 is a front elevation view of the light of FIG. 3 with the front housing component removed;

FIG. 5 is an exploded perspective view of one embodiment of the light for the lighted bill folder;

FIG. 6 is another exploded perspective view of one embodiment of the light for the lighted bill folder;

FIG. 7 is a rear elevation view of one embodiment of the light for the lighted bill folder;

FIG. 8 is a side cross-sectional view of the light for the lighted bill folder about line 8-8 of FIG. 7;

FIG. 9 is an enlarged cross-sectional view of a light refracting bezel for the light for the bill folder;

FIG. 10 is a front perspective view of one of the housing components for the bill folder light;

FIG. 11 is a rear perspective view of another of the housing components for the bill folder light; and,

FIG. 12 is an exploded perspective view of another embodiment of a light for a bill folder.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

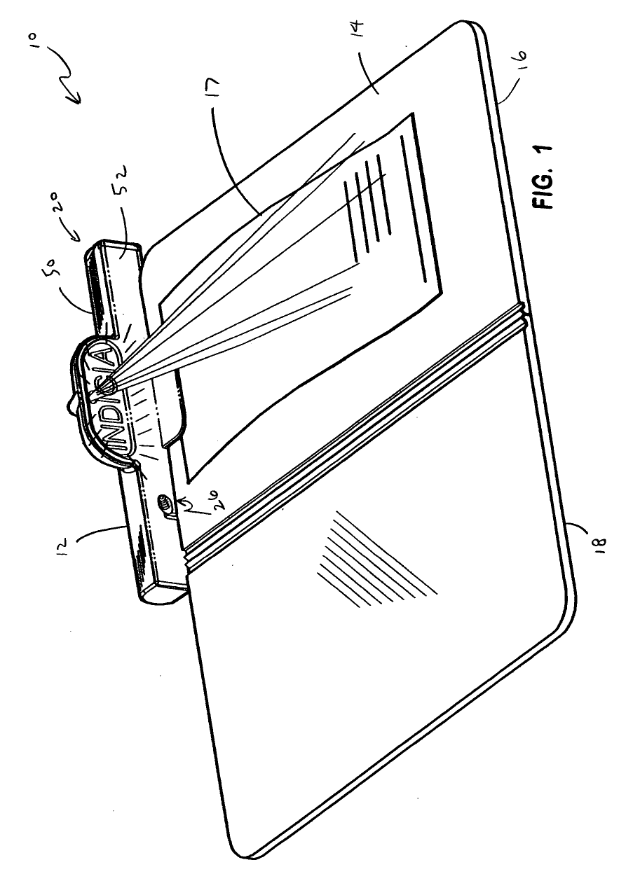

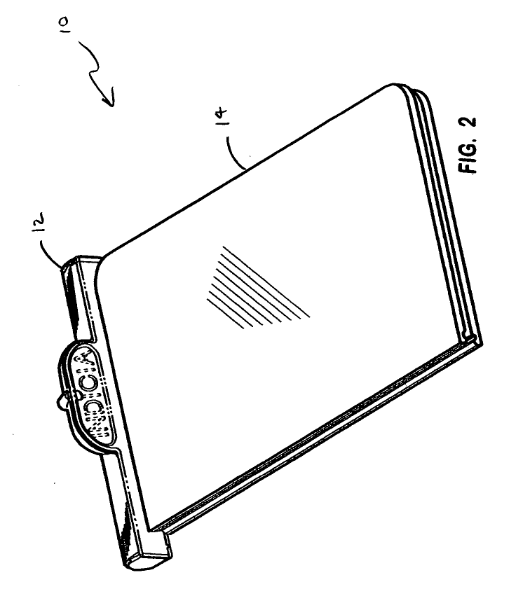

Referring now to the Figures, and specifically to FIGS. 1 and 2, there is shown a lighted bill folder 10 comprising a light module 12 and a bill folder 14. The light module 12 may be an integral or unitary component with the bill folder 14, or it may be a separate component that may be fixed and/or removably attached to the bill folder 14 as shown in the figures. Generally, the bill folder 14 comprises a hinged folder having a first flap 16 hingedly connected to a second flap 18. In one embodiment, the second flap 18 of the bill folder 14 is adapted for opening and closing, and the light module 12 is connected to the first flap 16 of the bill folder 14. A check or bill 17 is typically provided on or adjacent the inner surface of the first flap 16 of the bill folder 14. The light module 12 is adapted to illuminate an area of the inner surface of the first flap 16 of the bill folder 14, generally where a check 17 would reside when the bill folder 14 is in the open position, as shown in FIG. 1. Generally, when the second flap 18 is opened and/or lifted off the first flap 16 (FIG. 1), the switch 26, which is biased in the actuated or engaged position, is closed to close the circuit and illuminate the light 24, and when the second flap 18 is closed or placed on the first flap 18 (FIG. 2), the switch 26 is pressed downward, thereby opening the circuit and shutting off the light 24.

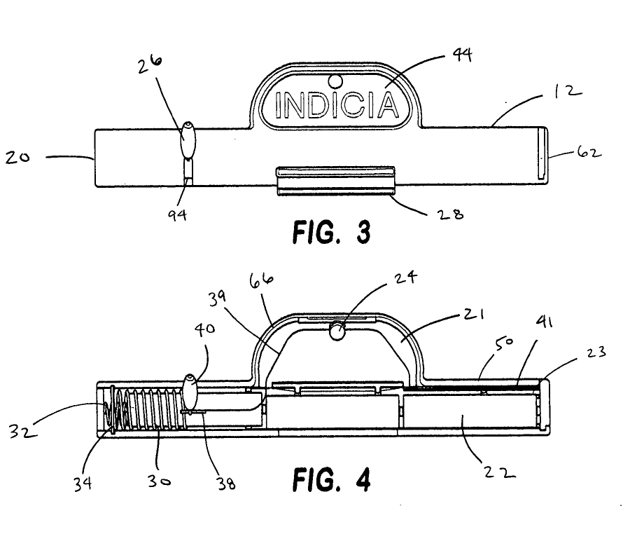

In one embodiment, as shown in FIGS. 3-9, the light module 12 generally comprises a housing 20, a first light source 24, and a switch 26. The housing 20 has a first cavity 21 in which the light source 24 is housed, and a second cavity 23 for housing a power source 22 for the light module 12. The housing 20 is preferably connected to the bill folder 14 in a fixed orientation to have the first light source 24 illuminate a check or bill 17 that may be provided within the bill folder 14 when the bill folder 14 is opened. In one embodiment the housing 20 may have an interface 28 for securing the light module 12 to the bill folder 14. The interface 28 is described in greater detail herein. Additional components in a preferred embodiment include a first spring 30, a second spring 32, a first conductive plate 34, a second conductive plate 36, a contact 38, a knob 40, and a removable panel 44.

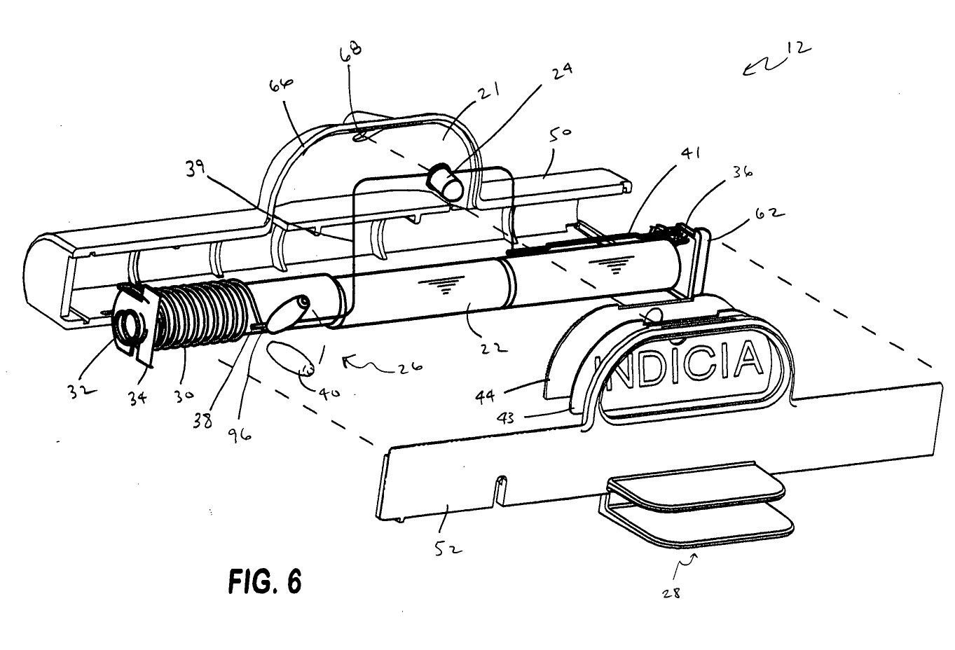

As shown in FIGS. 3 and 6, in this embodiment the housing 20 is comprised of a first housing member 50 and a second housing member 52, which define the first and second cavities 21, 23 therebetween. The housing 20 has a first end 56 and a second end 58. An opening 60 is provided at the first end 56 of the housing 20 to provide access to the cavity 23. Additionally, a removable side panel or closure member 62 is provided to close the opening 60 to the cavity 23. The housing 20 has a width associated therewith, i.e., the distance from the first end 56 of the housing 20 to the second end 58 of the housing 20. The width of the housing 20 is preferably approximately equal to the width of the bill folder 14, however, it is understood that the width of the housing 20 may be different from the width of the bill folder 14 without departing from the scope of the present invention. For example, as shown in FIG. 2, the housing 20 may be slightly wider than the bill folder 14. Additionally, it is understood that the first housing member 50 may be made of more or less components than described above without departing from the scope of the present invention. In a preferred embodiment, the housing members are made of a plastic material, such as ABS, which provides a lightweight but durable structure. It is understood, however, that numerous other materials may be utilized in place of plastic and still provide suitable functionality and operation of the housing.

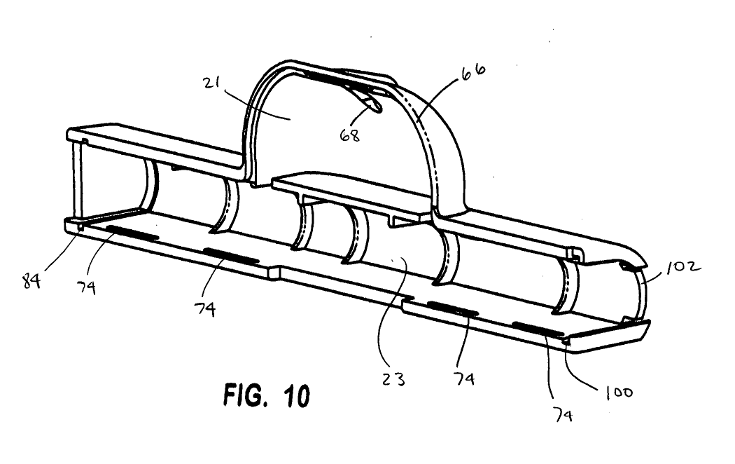

The first housing member 50 generally has a portion thereof that operates as a power-source compartment or cavity 23, a portion thereof that secures and directs illumination of the light source, and a portion thereof that is adapted to secure the second housing member 52 thereto. As shown in the embodiment of FIG. 10, the portion of the first housing member 50 that defines the power source compartment 23 in this embodiment comprises a generally U-shaped member 64, and the portion of the first housing member 50 that secures and directs illumination of the light source comprises an extension 66 from the U-shaped member 64. The U-shaped member 64 and cavity 23 extending therefrom is generally sized and shaped to accept the power source 22, which is typically at least one removable battery. More specifically, in the preferred embodiment the power source 22 comprises three “AAA” batteries provided in series, thereby providing approximately 4.5V. While the portion of the first housing member 50 for housing the power source 22 is generally U-shaped, it is understood that numerous other geometries would be acceptable without departing from the scope of the present invention.

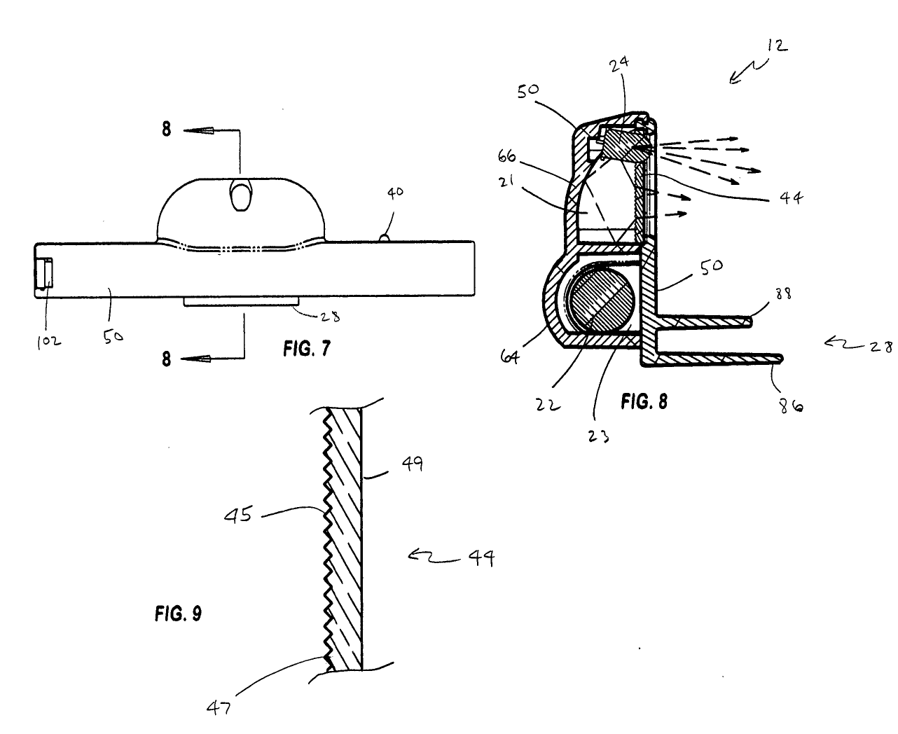

As best shown in FIGS. 8 and 10, the extension 66 contains a first mounting fixture 68 for securing the first light source 24 within the first housing member 50. The first fixture 68 is configured to orient illumination of the first light source 24 outwardly from the light module 12 and toward the first flap 16 of the bill folder 14. Further, however, in one embodiment as shown in FIG. 8, the first light source 24 is also configured to have a portion of its illumination directed in the first cavity 21 and out of the panel 44. Accordingly, in this embodiment the first light source 24 also operates as a backlight for any indicia on the panel 44. In a preferred embodiment, the first light source 24 is a light emitting diode (LED), and is preferably a bright white LED. Additionally, in a preferred embodiment, the inner surface of the first cavity 21 of the extension 66 may be coated with a white or other light color to reduce the absorption of light and increase the backlight brightness.

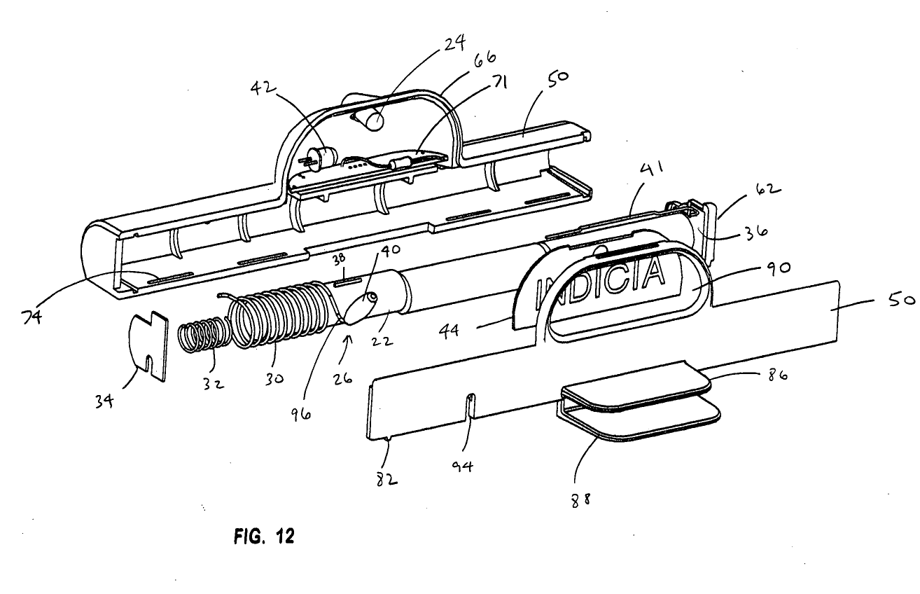

In an alternate embodiment as shown in FIG. 12, a second light source 42 and a second mounting fixture (not shown) for securing the second light source 42 within the first housing member 50 are provided. The second mounting fixture is configured to orient the illumination of the second light source 42 generally within the first cavity 21 of the extension 66, and as a primary backlight for the removable panel 44. In one embodiment the first and second light sources 24 and 42 are orientated transverse to one another, and in a preferred embodiment they are orientated approximately 90° to one another. Further, it is understood that the first and second light sources 24 and 42 may be mounted to a printed circuit board 71 to support the LED's in the proper orientation and to provide a convenient wire interconnect means. In the alternate embodiment of FIG. 12 the second light source 42 is also a LED, and is preferably a colored LED, such as a yellow or orange LED. In the alternate embodiment the first light source 24 generally provides the main source of illumination for the light module 12, and the second light source 42 generally provides a backlight for illuminating the removable panel or name plate 44.

While white and colored LED's are disclosed for the preferred embodiments, it is understood that different color LED's may be utilized with the light module 12. Additionally, while various embodiments utilize LED's for the light sources, it is understood that other forms of light sources may be appropriate without departing from the scope of the present invention. Notwithstanding, LED's operate on different principles than standard light bulbs and fluorescent lights, and thus provide advantages over these other types of lights. For example, standard light bulbs use a tungsten filament heated by electrons to produce illumination, and fluorescent tubes use gas to produce illumination. Conversely, LED's use photons of light produced by layers of alloy crystals when electrons move through them. Specifically, crystalline layers in the LED's convert electrical input into optical output at a color determined by the exact composition of the material comprising the crystalline layers. Further, LED's are at least twice as efficient as an incandescent light bulb, they use less electricity than an average light bulb, and they shine for a longer time before burning out. As opposed to incandescent light bulbs, which convert only about 5-10% of the electrical power supplied to it into light, as well as fluorescent tubes, which convert about 20-30% of the electrical power supplied to them as light, LED's can convert more of their electrical power into light. Accordingly, for this intended use in the light module 12, LED's are preferred to other types of light sources for the above reasons.

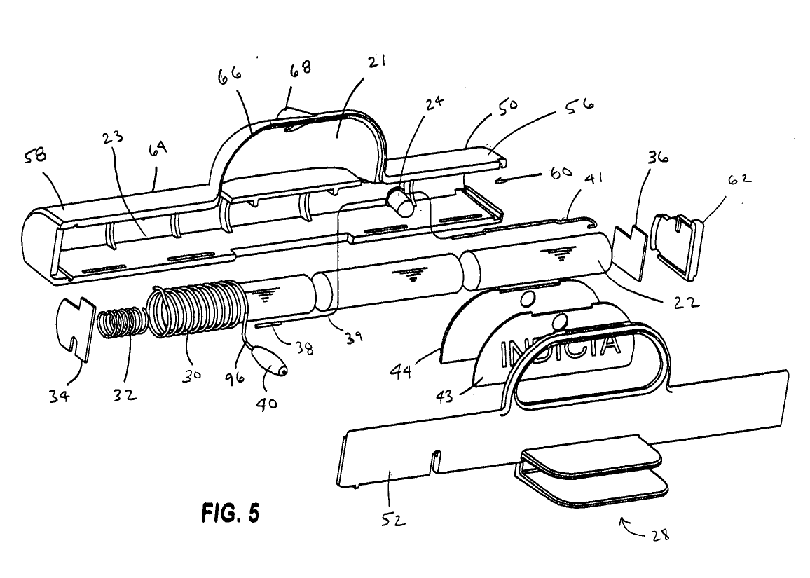

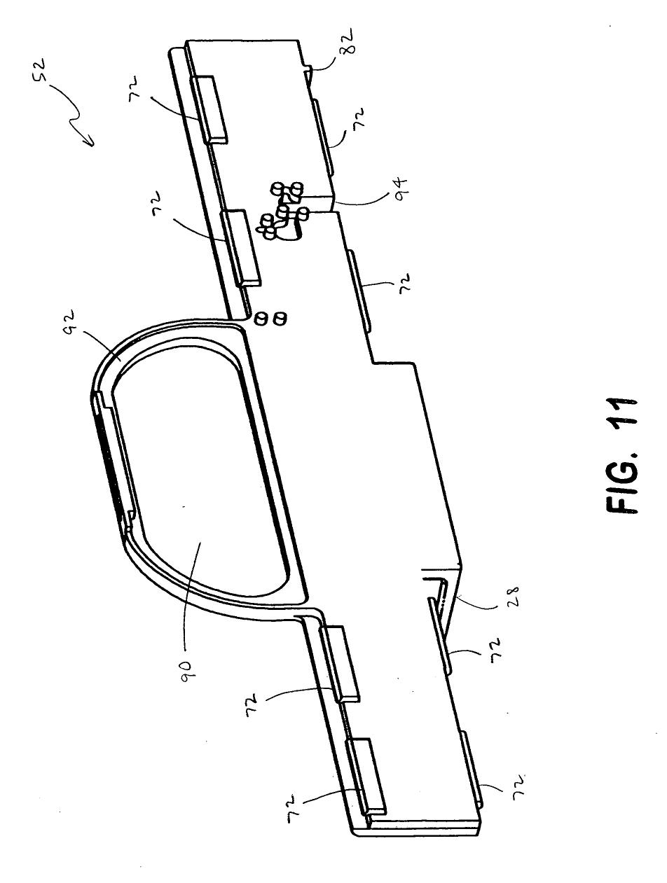

Referring now to FIGS. 5-6, 8 and 11-12, the second housing member 52 generally comprises a cover for closing off the cavities 21 and 23 of the housing 20. Accordingly, in this embodiment the second housing member 52 is a substantially planar member that mates with first housing member 50. Referring to FIGS. 10 and 11, the second housing member 52 has a plurality of attachment members 72 which engage mating receivers 74 on the first housing member 50. In one embodiment, the attachment members 72 comprise tabs 72 that extend from the second housing member 52, and the receivers 74 comprise mating detents or slots 74 that receive the attachment members 72. The tabs 72 extend from both the upper and lower portions of the second housing member 52 to appropriately secure in a snap-fit manner the second housing member 52 to the first housing member 50. Additionally, the second housing member 52 may have a key 82 which mates with an opening 84 in the first housing member 50 to align the second housing member 52 laterally with the first housing member 50. Thus, in this embodiment the second housing member 52 can be snap fit to the first housing member 50 to form the housing 20.

As explained above, the housing 20 may have an interface 28 for securing the light module 12 to the bill folder 14. In one embodiment the interface 28 is a mounting member comprised of first and second mounting flanges 86 and 88. The mounting flanges 86 and 88 extend transversely from the second housing member 52, and are spaced apart a distance to provide for securing the first flap 16 of the bill folder 14 therebetween, such as with a pressure fit, clamping mechanism or other means such as an adhesive. Accordingly, a portion of the bill folder 14 is clamped or pressure fit between the first and second mounting flanges 86 and 88 to secure the light module 12 to the bill folder 14. In a preferred embodiment an adhesive, such as tape, is also utilized to provide a secure connection between the interface 28 of the light module 12 and the bill folder 14. As shown in FIG. 8, the interface 28 has first and second arms 29, 31 which extend from the second housing member 52 in a vertically spaced relationship, and in a plane generally offset from the plane of the first light source 24, such that when the switch 26 is provided in the off position, described in detail herein, the knob 40 of the switch 26 is positioned between the first and second flaps 16 and 18 of the bill folder 14.

The second housing member 52 also has an opening 90 with an internal recessed portion 92 adjacent the perimeter of the opening 90. The recessed portion 92 of the opening 90 is sized to seat a marketing panel 44 therein. The panel 44 generally comprises a clear, translucent or semi-translucent bezel having indicia thereon that can be customized for the particular application and/or customer. In one embodiment the panel 44 is made of a clear polycarbonate, however, one of ordinary skill in the art would understand that the panel 44 may be made of other material without departing from the scope of the present invention. The indicia on the panel 44 may be comprised of a separate component, such as a translucent decal or sticker 43, or it may be comprised of printing directly on the front surface 49 of the panel 44. Referring to FIGS. 8 and 9, in one embodiment the panel 44 has a plurality of facets 45 on its rear surface 47. The facets 45 assist to refract light in parallel rays as shown in FIG. 8, thereby brightening the image on the front surface 49 of the panel 44. In one embodiment, as shown in FIG. 8, the first light 24 is set further back in the first cavity 21 to provide additional scattered light as a backlight or diffusion light for illuminating the panel 44.

As shown in FIGS. 5-6 and 11, the opening 90 in the second housing member 52 is provided adjacent the extension 66 portion of the first housing member 50. Further, as shown in FIGS. 3-6, the second housing member 52 also has an aperture 94 through which a portion of the switch 26 extends. In a preferred embodiment, the portion of the switch 26 that extends through the aperture 94 in the second housing member 52 is a leg portion 96 of the first spring member 30.

In general, the switch 26 is a component for opening and closing an electrical circuit to selectively provide power from the power source 22 to the first light source 24 and/or the second light source 42 for selectively illuminating the appropriate light sources 24 and 42. To accomplish opening and closing the electrical circuit, the switch 26 is repositioned from a first or normal position to a second or actuated position. The second or actuated position is shown in FIGS. 1, 3, 4, 6 and 12. The first or normal non-actuated position is shown in FIGS. 2 and 6 (in phantom). In the first position of the switch 26, the electrical circuit supplying power to the light sources 24 and 42 is opened and thus the light sources 24 and 42 are not illuminated. Conversely, in the second or actuated position of the switch 26, the circuit supplying power is closed, and thus power is supplied to the light sources 24 and 42 to illuminate the light sources 24 and 42.

Referring to FIGS. 4-6, the switch 26 extends from a front surface of the housing 20. The switch 26 has a spring component, such as the first spring member 30, and a knob 40 connected to a leg 96 of the first spring 30. In one embodiment the first spring member 30 is preferably a torsion spring. The torsion spring 30 provides a torque to bias the knob 40 connected to the first spring 30 toward the second or actuated position. By supplying a resistant force on the switch 26, i.e., pushing the switch 26 downward by closing the second flap 16 on the first flap 14, to open the circuit and cut the flow of current to the light sources 24 and 42, the lights are turned off. For reference, the first spring 30 is in electrical communication with the first negative contact conductive plate 34, which is electrically connected to the negative pole of the power source 22 through compression spring 32.

Referring further to FIGS. 4-6, the light module 12 also has a contact 38. The contact 38 is in electrical communication with the light sources 24 and/or 42 through a cathode connection wire 39, as well as the positive pole of the power source 22, through an anode contact wire 41. To close the electrical circuit, and join the light sources 24 and 42 with the positive and negative poles of the power source 22, the switch 26 is moved to the second or actuated position. In the actuated position the leg 96 of the first spring 30 electrically contacts the negative contact plate 38, thereby closing the circuit and providing power to illuminate the light sources 24 and 42. To turn the lights 24 and 42 off, the switch 26 is moved to its first position, thereby electrically disengaging the first spring 30 of the switch 26 from the contact 38 and opening the circuit. It is understood that alternative embodiments of the switch are readily available without departing from the scope of the present invention. For example, the switch may be a pressure activated switch that is operated by the user, i.e., the customer.

As explained above, in one embodiment the power source 22 is a plurality of batteries. The batteries are provided in series within the cavity 21 of the housing 20. The negative pole of the leading battery is in electrical communication with the first conductive plate 34 (which is also in electrical communication with the first spring 30 as described above through second spring 32). A second spring 32, typically a compression spring, is provided to also be in electrical communication with the first conductive plate 34. The second spring 32 provides a resistive force to maintain the plurality of batteries in contact with one another and in further contact with the first and second conductive plates 34 and 36.

The second conductive plate 36, generally a positive contact plate, is generally provided in fixed communication with the removable side panel 62. When the removable side panel 62 is positioned in place, as shown in FIGS. 3-4, and thereby connected to the housing 20, the second conductive plate 36 is in electrical communication with the positive pole of the power source 22. More specifically, the second spring 32 provides a force to push the series of batteries against the second conductive plate 36. For reference, the second conductive plate 36 is further in electrical communication with a wire 41, as shown in FIGS. 4-6 and 12, which is part of the circuit in electrical communication with the light sources 24 and 42. The white LED of the first light source 24 generally requires the full 4.5V of the power source 22, however, the colored LED's, if utilized, of the second light source 42 generally require a lower current. Accordingly, a current limiting resistor may be employed in the electrical circuit between the positive lead and the cathode of the second light source 42 to lower the current provided to the second light source 42.

To provide for insertion and removal of the removable side panel 62, the housing 20 has a receiver 100 in the form of a slot 100 (See FIGS. 4-6, 10 and 12) which allows the removable side panel 62 to slide therein for appropriate positioning of the side panel 62 and for electrical engagement between the second conductive plate 36 and the power source 22. Further, the first housing member 50 has a snap extension 102 which provides for removably securing the side panel 62 in place.

Referring to FIGS. 1 and 2, the light module 12 is generally connected in a transverse position to the bill folder 14, and the light source 24 is generally raised from a plane of the bill folder 14. Additionally, in a preferred embodiment the light source 24 is directed at an angle toward the surface of the bill folder 14.

In use, the first spring 30 is biased to rotate the switch 26 to the actuated position. When the bill folder 14 is in the closed position, however, the first flap 16 of the bill folder 14, i.e., the flap that is adapted to open and close, is provided generally in a position substantially parallel to the plane of the second flap 18, and the knob 40 is positioned between the first and second flaps 16 and 18 in the first position. As such, the electrical circuit is open, and the light sources are off. The weight of the first flap 16 is sufficient to overcome the torque of the first spring 30 to retain the switch 26 in the first position. When the bill folder 14 is opened, however, the first flap 16 is raised allowing the first spring 40 to reposition the switch 26 to the second position. In the second position the leg 96 of the first spring 30 electrically contacts the contact 38, thereby closing the electrical circuit and joining the light sources 24 and 42 with the positive and negative poles of the power source 22. To turn the lights 24 and 42 off, the first flap 16 is rotated toward the closed position, thereby engaging the knob 40 and repositioning the switch 26 from the actuated position to the first position. As the switch is repositioned out of the actuated position the first spring 30 is electrically disengaged from the contact 38 and circuit is opened, thereby eliminating power to the lights and turning the lights off. In an alternate embodiment, the light module 12 may have a timer or modulator, such as on a printed circuit board, which will operate to turn the lights off after a preset period of time has elapsed and/or to modulate or flash the lights.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying claims.

What is claimed is:

1. A lighted bill folder, comprising:
a bill folder having a first flap; and,
a light module connected to the first flap of the bill folder, the light module having a housing, a switch extending from the housing, and a light source electrically connected to the switch, the light source directing illumination toward a surface of the first flap.

2. The lighted bill folder of claim 1, further comprising a light mount in a cavity of the housing for directing the light toward the first flap.

3. The lighted bill folder of claim 1, further comprising at least a partially translucent panel in the housing, the panel receiving backlight from illumination in a cavity of the housing.

4. The lighted bill folder of claim 3, wherein a surface of the translucent panel is faceted.

5. The lighted bill folder of claim 3, wherein a portion of the interior cavity of the housing is provided with a light color to increase the backlight brightness.

6. The lighted bill folder of claim 3, further comprising one of a design or indicia on the panel, and wherein internal illumination from the light module operates as a backlight for illuminating the panel.

7. The lighted bill folder of claim 1, further comprising a second light source within a cavity of the housing, the second light source directing illumination within the cavity of the housing and out of the panel.

8. The lighted bill folder of claim 1, further comprising a second flap pivotally connected to the first flap.

9. The lighted bill folder of claim 1, further comprising first and second interface members extending from the housing to engage the bill folder and connect the bill folder to the light housing.

10. A light for a bill folder having a first flap pivotally connected to a second flap, comprising:
a housing having a cavity, an illumination source located in the cavity, and a switch electrically connecting a power source and the illumination source when in an actuated position, wherein the housing has a mounting member extending from the housing, the mounting member configured to secure a bill folder thereto such that the light in the housing is fixed in position to illuminate a surface of the bill folder.

11. The light of claim 10, wherein the illumination source is angled downwardly to illuminate a bill on the bill folder.

12. The light of claim 10, wherein the switch is biased in an actuated position.

13. The light of claim 10, further comprising a panel in a face of the housing, the panel being illuminated by backlighting from the illumination source.

14. The light of claim 13, wherein the panel has a faceted rear surface.

15. The light of claim 10, further comprising a second light electrically connected to the power source and the switch, wherein the light illuminates a surface of the bill folder, and wherein the second light provides a back light.

16. The light of claim 10, wherein the switch is actuated from a first position to a second position, and wherein the bill folder engages the switch in the first position to open a light circuit.

17. The light of claim 10, further comprising a spring connected to the switch to assist in manipulating the switch and closing a light circuit.

18. A light module for a bill folder having a first flap pivotally connected to a second flap, comprising:
a housing having a cavity with at least one illumination source located therein, a translucent panel adjacent the cavity, and a switch electrically connecting a power source and the illumination source when in an actuated position, wherein the housing has a mounting member extending from the housing and configured to secure a bill folder thereto, and wherein the translucent panel is illuminated by backlighting from the at least one illumination source.

19. The light of claim 18, wherein the mounting member comprises a first and second adjacent extensions configured to engage a portion of the bill folder therebetween.

20. The light of claim 18, wherein the switch is biased in an actuated position.
